(19) United States
(12) Patent Application Publication
(10) Pub. No.: US 2014/0300980 A1
(43) Pub. Date: Oct. 9, 2014

(54) Two mirrored visual aid device that broadens an otherwise limited visual field

(71) Applicants: Judy Anne Simon, Sandy, OR (US); Lora Lee Franke, La Jolla, CA (US)

(72) Inventors: Judy Anne Simon, Sandy, OR (US); Lora Lee Franke, La Jolla, CA (US)

(21) Appl. No.: 13/857,663

(22) Filed: Apr. 5, 2013

(51) Int. Cl. G02B 7/00; G02B 7/182

(52) U.S. Cl. CPC G02B 7/002; G02B 7/182
USPC 359/850

(57) ABSTRACT

Two mirrors are encased in a padded fabric frame resembling a notebook that is secured to the body by adjustable neck and waist straps for hands free use. The device may also be hand held. Mirrors are set to the optimal angle for the user. The upper mirror reflects the forward/peripheral view, and the lower mirror displays this view as an upright image to the wearer. The conversation partner has an upright view of the wearer's face, as well. For bicycle use, smaller more rigid frame is recommended for placement on the handle bars.

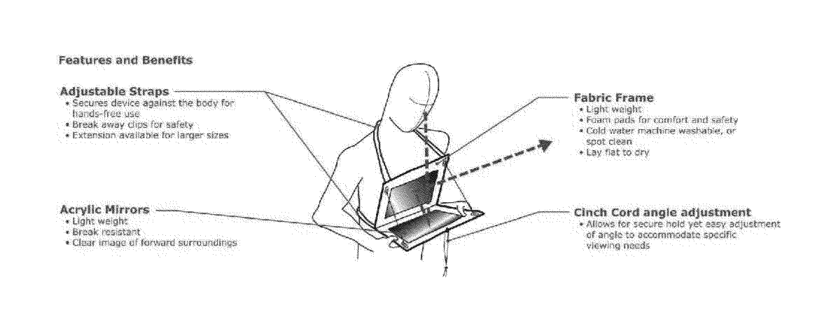

The device is comprised of the following elements:
Two rectangular (square, oval, round, etc.) break resistant mirrors of polycarbonate or other highly polished reflective surfaces which may be of varied sizes, depending upon the particular need of the user. (Convex lower mirror may be used to broaden visual scope for people with limited peripheral vision.)
Two sturdy yet flexible surfaces, such as rubber or synthetic foam, to provide padded support to the mirrors.
Fabric frame to hold mirrors in place.
Adjustable straps for securing the device to the patient's body. May be made of fabric, leather, etc.

May have break away clips to prevent hanging hazard.
Cord with cinch toggle or other means to secure proper length for setting and holding the angle, and to secure closure of the frame when the device is not in use.

The mirrors and backing may be removed for laundering the frame and straps.

### BRIEF DESCRIPTION OF DRAWING

The top of the upright portion of the frame holding one mirror has button hole type openings at each corner to feed straps through. The top strap forms a loop to be placed around the neck. This section of the strap has a break away clip worn at the nape of the neck for emergency release. The remainder of the strap material feeds through near the lower edge of the upright portion for securing at the waist, and is fastened with a clip, Velcro, snap, or other mechanism. A cinch cord is fed through the same button hole openings, across the top of the upright panel and through grommets on each corner of the outside edge of the lower frame, and held by a cinch clip to secure the closure of the notebook style frame, and to adjust the angle of the panels to each other at the optimal position for a forward, peripheral view of the environment.

What the Claimed is:

1. A visual device providing forward and peripheral view for persons with limited visual field due to various medical conditions or other reason.
